(19) United States
(12) Patent Application Publication
(10) Pub. No.: US 2014/0265334 A1
(43) Pub. Date: Sep. 18, 2014

(54) ENERGY GENERATOR POWERED BY GYM FACILITY

(71) Applicant: Michael Reitman, Montclair, NJ (US)

(72) Inventor: Michael Reitman, Montclair, NJ (US)

(21) Appl. No.: 13/844,705

(22) Filed: Mar. 15, 2013

(51) Int. Cl. H02J 7/14

(52) U.S. Cl. CPC H02J 7/14
USPC 290/50

(57) ABSTRACT

An energy generator system for converting mechanical energy from a workout or otherwise physical environment to electricity. The energy generator is integrated within workout machines for converting the kinetic energy or mechanical energy to electricity. At least one battery or electricity storage device is provided wherein the electricity is stored or appointed for consumption. As the exercise equipment is being used the kinetic or mechanical energy given off is converted to electrical energy by way of the generator, which transfers the electricity to the battery wherein it is stored or transferred for direct use.

### BACKGROUND OF THE INVENTION

1. Field of the Invention

The present invention relates to a generator that converts kinetic energy generated from mechanical equipment and harnesses it for electrical distribution.

2. Description of the Prior Art

Electrical energy is a necessity in modern day living. Costs of electricity can vary greatly based on geographical location and consumption. Large facilities and/or businesses electricity costs can be very high and represent an expensive, yet necessary, operational expense. Self sustaining energy is optimal for many businesses, but unfortunately unfeasible. During power outages, or in locations where electricity is otherwise unavailable, generators are commonly utilized to supply electrical power.

Generators are also sometimes used as secondary sources of electricity. Typical generators are not utilized regularly owing to operational costs associated with fuel to run the generator. Mechanical generators have the advantage of operating with little or no fuel. However, these type of generators require mechanical movement of a person or an animal—such as view a bicycle and/or hand crank.

Various generators have been heretofore disclosed and utilized. Some examples are set forth herein below.

U.S. Pat. No. 4,616,823 to Yang discloses a exercise bicycle with inclined seats for two people that includes a stationary frame attached to a first seat, a pedal assembly, and a frictional fly wheel assembly coupled to the pedal assembly and offers resistance to the rotation of the pedal assembly. An electro-mechanical assembly (e.g., a dynamotor, a generator or the like) is coupled to the pedal assembly to rotate the pedal assembly or to generate electrical power in response to manual rotation of the pedal assembly at the selection of a user.

U.S. Pat. No. 7,021,978 to Jansen discloses a human-powered generator system for electric watercycles with a control means whereby the perceived mechanical properties of the pedal mechanism and electric pedal-powered generator are adjustable by the operator. The invention provides a means whereby the rotational inertia and damping of the input pedal mechanism, including generator, as perceived by the operator can be increased or decreased as desired. The control means with further properties such that the input pedal mechanism as perceived by the operator can be made to mimic that of bicycle; i.e., with large inertia when pedaling in the forward direction, a very low inertia when pedaling in the reverse direction, and a freewheeling clutch mechanism whereby the large inertia is disengaged when not pedaling in the forward direction with a forward torque.

U.S. Pat. No. 7,851,932 to Rome et al. discloses an electricity-generating backpack that is substantially lighter in weight, has the multiple springs replaced with one large spring whose spring constant can be adjusted in the field in seconds, and replaces a DC generator with a brushless AC generator that permits approximately 70% generator efficiency and the generation of up to 20 W of electrical power by converting mechanical energy to electrical power. A device is provided that always removes some electricity, but not too much, as necessary to extract large levels of the electricity while controlling damping by providing electrical damping circuits including a DC-DC converter designed to emulate a desired load at its input terminals. Additional electricity generating E-MOD devices may be used for generating additional power by hooking an E-Mod device to a generator and to the backpack belt at the wearer's hip and includes a wand that fits against the wearer's femur so as to move through a range of motion as the patient walks.

U.S. Pat. No. 8,342,546 to Bryant discloses an in-line, two-wheeled vehicle, with a torque generator operably secured thereto. The torque generator generates a defined auxiliary torque about the point-of-contact of the steering wheel, and it is sized to balance the naturally occurring torques arising at slow speeds about the point-of-contact of the steering wheel, thereby improving the stability and control of the vehicle. In one disclosed embodiment, the vehicle is a stand-up riding board. In another disclosed embodiment, the vehicle is a cycle, such as a bicycle or the like. Torque generator structures such as using an elastic member, mechanical linkage, and dampening systems are also disclosed.

U.S. Pat. App. Pub. 20050253355 to Nacer discloses a system and the method of providing an efficient human powered vehicle by means of using levers that transmit the force produced on them to a rotational mechanism making move one or more wheels to the driving wheels of an bicycle, tricycle or vehicle where the rotational mechanism might be enclosed inside a negative pressure chamber containing one or more multiplying gears in communication to an electricity generator which provides power to batteries which provide power to the engine that moves the vehicle which is equivalent to transforming the our biological force into mechanical force then into electrical and finally into movement.

U.S. Pat. App. Pub. 20130049374 to Chen discloses a manual mechanical leg-stepping power generating apparatus includes a leg pedal installed separately on both left and right sides of a seat pole of a bicycle, moved up and down at a position adjacent to a rider's thigh muscle, and coupled to a connecting shaft through a leg pedal link rod. Another side of the connecting shaft is coupled to a power generator shaft on the seat pole by using a support rod. The leg pedals are moved up and down alternately to drive a power generator installed in a power generator to generate electric power. When a rider rides the bicycle, kinetic energy is generated by a force applied by the rider's thigh onto the leg pedals and converted into electric energy by the leg pedals, power generator shaft and the power generator set, such that the electric energy can be supplied for the use by electric devices.

Nonetheless, there remains a need in the art to provide a mechanical generator that has access to large sums of kinetic energy as the average person will only likely utilize an exercise device or bicycle, for example, for approximately an hour on a few days a week. The amount of energy accumulated from that time may only be enough to light a light bulb for a short time, or provide some battery rechargeable life to a mobile device.

There remains a need in the art for an energy generator system that provides enough human power to make the system worthwhile in considering the costs. What is more, there is a need in the art for a mechanical energy generator system to be capable of providing compensation to the operator.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

The present invention is intended to overcome at least the above-described disadvantages. The objects and advantages of the present invention, more specifically, are to provide an energy generator system that provides enough human power to make the system a good return on investment. Specifically, the present invention provides a mechanical energy generator system that is capable of generating compensation to the operator of the system.

In particularly, the present invention provides a means for a health club or fitness center to provide at least some of its own sustainable electrical energy, or optionally sell energy to an energy supplier for compensation through use of mechanical energy generated at the club during workouts. The invention provides for the harnessing of kinetic energy given off when gym members exercise.

Facilitating the above-mentioned objectives, the subject invention is directed to a generator uses the mechanical or kinetic energy supplied to it from at least one workout machine to force the movement of electric charges present in the generator's wire windings/electrical conductor integrated within the workout machine through an external electric circuit. The external electrical circuit is delivered output electric current from each of the generators associated with each of the workout machines. Output electric current is supplied by each generator to the external electric circuit.

In one aspect of the present invention an energy generator system for converting mechanical energy from a workout or otherwise physical environment to electricity is provided. The energy generator is integrated within workout machines for converting the kinetic energy or mechanical energy to electricity. At least one battery or electricity storage device is provided wherein the electricity is stored or appointed for consumption. As the exercise equipment is being used the kinetic or mechanical energy given off is converted to electrical energy by way of the generator, which transfers the electricity to the battery wherein it is stored or transferred for direct use.

### BRIEF DESCRIPTION OF DRAWINGS

The invention will be more fully understood and further advantages will become apparent when reference is had to the following detailed description and the accompanying drawings, in which:

FIG. 1 is a schematic diagram of a preferred embodiment of the subject fitness club energy generator system in a gym workout room environment;

FIG. 2 is a schematic diagram of a preferred embodiment of the subject fitness club energy generator system in a gym workout room environment;

FIG. 3 is a block diagram of an embodiment of the subject energy generator system;

FIG. 4 is a diagram overview of an embodiment of the subject generator system.

### DESCRIPTION OF THE PREFERRED EMBODIMENTS

Certain terminology is used in the following description for convenience only and is not limiting. The article “a” is intended to include one or more items. Where only one item is intended, the term “one” or similar language is used. Additionally, to assist in the description of the present invention, words such as top, bottom, front, rear, right and left are used to describe the accompanying figures. The terminology includes the words above specifically mentioned, derivatives thereof, and words of similar import.

It is noted that although the subject invention has particular applications in a gym or health club environment where members carry out exercise activities, the subject invention may also be used in a plethora of venues. Examples include, at amusement parks, and/or other social or gatherings.

The present system's generator converts kinetic energy generated on exercise equipment during exercising, such as “spin cycles” and elliptical machines that are generally prevalent in health clubs, to electrical energy. All things that move contain kinetic power and that power can be computed using the formula: K= 1/2 mv² (K=kinetic energy, v=velocity, m=mass). When a person at a health club is working out on a spin cycle or elliptical machine, the kinetic energy generated can be converted to electrical energy which, in turn, can be stored or transferred to an electrical grid for compensation.

The electric generator converts kinetic energy obtained from an external source, specifically a plurality of work out machines in a health club, gym or workout facility, into electrical energy that can immediately be utilized as electrical output, stored by way of a plurality of batteries, or output to an electric grid for immediate use by third parties and compensation to the gym/health club.

The subject generator uses the mechanical or kinetic energy supplied to it from at least one workout machine to force the movement of electric charges present in the generator's wire windings/electrical conductor integrated within the workout machine through an external electric circuit. The external electrical circuit is delivered output electric current from each of the generators associated with each of the workout machines. Output electric current is supplied by each generator to the external electric circuit.

FIGS. 1-3 broadly illustrate embodiments of the system of the subject fitness club energy generator.

Referring to FIGS. 1-3; the energy generator is shown generally at 10. The system is adapted to preferably be utilized in a health club setting wherein nearly 24 hours of exercise mechanical energy is collected throughout a day, depending on the club's hours and members. Home or office use of the system is also contemplated; however the mechanical energy level may not be as high inasmuch as the volume of users of the exercise machinery and/or intensity of the workout will likely be lower. Generally, the system 10 includes a plurality of exercise equipment 11 (11a-n, n being any number equal to or greater than 1) each with a generator 12 integrated therein. The generator may be constructed as discussed herein below regarding FIG. 4, or may be a dynamotor, a generator or the like.

As a user is uses the exercise equipment 11 kinetic or mechanical energy given off which is converted to electrical energy by way of the generator 12. Generator 12 transfers the electrical energy to a battery 13 wherein it is stored or transferred for direct use, or transferred to an electrical grid for compensation. The converted electrical energy can also be used to recharge storage batteries on or off the kinetic generation site.

FIG. 4 illustrates a schematic of the subject generator system, shown generally at 400. Generator 401 includes a source of input mechanical energy which is a workout device or machine 402. The workout device or machine 402 includes a source of input of mechanical energy which is predicated on the type of workout machine 402 is. For example, where the workout machine 402 is a bicycle, elliptical or stepper machine, typically a spinning wheel is driven/spun by the user of the device; wherein the machine 402 is treadmill it generally includes a platform with rotating elements. The size of the engine, or in this case mechanical wheel size of the workout machine, is directly proportional to the maximum power output the generator can supply. However, owing to the use of several machines throughout the workout facility, the maximum power output is readily compounded based on the number of gym users.

An alternator 403 produces the electrical output from the mechanical input supplied by the machine 402. Alternator 403 contains an assembly of stationary (stator) and moving parts (rotor) encased in a housing wherein the components work in concert to cause movement between the magnetic and electric fields, which in turn generates electricity. The moving part (rotor) generates a moving magnetic field around the stationary part (stator), which induces a voltage difference between the windings of the stator and produces alternating current (AC) output of the generator. A voltage regulator 404 is used for the conversion of AC Voltage to DC current. The voltage regulator takes up a small portion of the generator's output of AC voltage and converts it into DC current. The voltage regulator 404 regulates the voltage through a series of cycles, which continue until the generator 401 begins to produce output voltage equivalent to its full operating capacity. As the output of the generator increases, the voltage regulator 404 produces less DC current. Once the generator reaches full operating capacity, the voltage regulator 404 equilibrates and produces just enough DC current to maintain the generator's output at full operating level. Electricity from the generated may be directly fed into the gym's electrical supply. Alternatively, the electricity may be stored in battery packs or circuits for later use/or as a secondary electric supply. Preferably, the electricity is sold to an electric company or distributor based on the KWH and the gym is thusly compensated for the KWH supplied. In an alternative embodiment, the gym may offer workout incentives to frequent gym members to work out harder, longer or more frequently and generate workout KWH that may be provided as a percentage compensation to the gym member or be provided in the form of coupons for local establishments, coupons for store, and/or other promotional goods and services.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. An energy generator system for converting energy from a physically active environment, comprising:
a. a plurality of exercise equipment adapted to be used by a plurality of people that produce kinetic or mechanical energy;
b. said exercise equipment having a generator integrated therein for converting said kinetic energy or mechanical energy to electricity;
c. at least one battery or electricity storage device wherein said electricity is stored or appointed for consumption;
wherein as said exercise equipment is being used said kinetic or mechanical energy given off is converted to electrical energy by way of said generator, which transfers said electricity to said battery wherein it is stored or transferred for direct use.

2. An energy generator system for converting energy from a physically active environment as recited by claim 1, wherein each of said exercise equipment has its own generator assembly integrated therein.

3. An energy generator system for converting energy from a physically active environment as recited by claim 1, wherein said electricity of said generated is directly fed into an electrical system of said gym.

4. An energy generator system for converting energy from a physically active environment as recited by claim 1, wherein said generated electricity is directly fed into a power grid for consumption.

5. An energy generator system for converting energy from a physically active environment as recited by claim 4, wherein compensation is provided in relation to the amount of electricity.

6. An energy generator system for converting energy from a physically active environment as recited by claim 1, wherein uses of a gym may be compensated for his/her kinetic energy.
